(19) United States
(12) Patent Application Publication
(10) Pub. No.: US 2019/0243846 A1
(43) Pub. Date: Aug. 8, 2019

(54) SENTENCE EXTRACTING APPARATUS, PROGRAM

(71) Applicant: KONICA MINOLTA, INC., Tokyo (JP)

(72) Inventor: Junya MURASHITA, Tokyo (JP)

(73) Assignee: KONICA MINOLTA, INC., Tokyo (JP)

(21) Appl. No.: 16/258,301

(22) Filed: Jan. 25, 2019

(30) Foreign Application Priority Data
Feb. 2, 2018 (JP) 2018-017663

(51) Int. Cl. G06F 16/31; G06F 16/35

(52) U.S. Cl. CPC G06F 16/313; G06F 16/353

(57) ABSTRACT

A sentence extracting apparatus includes: a hardware processor that analyzes a logical configuration of a document; extracts a first sentence including a specific key word from the document; and extracts, as a related sentence, another sentence located in a predetermined range starting from the first sentence, in the logical configuration.

The entire disclosure of Japanese patent Application No. 2018-017663, filed on Feb. 2, 2018, is incorporated herein by reference in its entirety.

### BACKGROUND

### Technological Field

The present invention relates to a sentence extracting apparatus and a program capable of extracting a sentence including important information from a document including a plurality of sentences.

### Description of the Related Art

In many companies, documents (such as weekly reports) are created for reporting progress of work, and the documents are submitted to senior administrators. However, since these documents have a large amount of information and also the way of writing varies for each person, the senior administrators have taken a lot of time to read the documents to grasp important problem information and the like from the documents.

A method has therefore been devised of extracting and displaying important information from a document. As a method of extracting useful information from a text (sentence), there is a method called text mining. According to the method, for example, words and the like having a negative meaning such as “fault” can be extracted from the text and collected together. By reading the extracted portion, it is possible to easily confirm only the useful information in the document without reading the entire document.

Regarding how to determine a sentence to be extracted out of the document, for example, as a conventional technique, there is a method in which a sentence is divided into words, and weighting of the entire sentence is performed by using the importance (weight value) of each word, and a sentence with high importance is displayed. As other methods of detecting a specific sentence from a document, there are methods as follows.

In JP 04426894 B2, a method is disclosed of detecting a sentence considered to be important, from a large number of documents, by comparing a search result obtained by using a key word considered to be important from a sentence input as a search condition with a search result obtained by using a key word of the entire sentence input.

In JP 2011-238159 A, a method is disclosed of extracting an important portion from a range specified in a document by using a determination rule efficiently generated by machine learning from a large number of case documents.

In U.S. Pat. No. 7,493,252, a method is disclosed of extracting information considering dependency of a key word in the same sentence, instead of extracting a key word as a simple character string, in a system that extracts features from information such as complaints, problems, and opinions from customers. For example, it is possible to extract, from a sentence “MODEM and Ethernet (registered trademark) card cannot be used” that is an original document, information of “MODEM . . . unusable” and “Ethernet (registered trademark) card . . . unusable”.

When the sentence to be extracted is determined, it may be better to consider factors other than the sentence. In most cases, a document has a meaningful hierarchical structure such as a chapter, a section, an item, a body text, and the like to enhance readability. When information (for example, a development phase, a target model, and the like) common to a lower hierarchy is expressed in an upper hierarchy, the information may be omitted in the body text. Even if information extraction processing is performed merely on each body text, there are therefore cases where important problem information cannot be grasped.

In a certain sentence, problem information is not described, but contents are sometimes described that supplement problem information described in other sentences of the same hierarchy. To allow the senior administrator to understand the problem information in detail, such a supplementary sentence should also be extracted, but even if information extraction processing is performed merely on each body text, the supplementary sentence is not extracted and the senior administrator cannot grasp the problem information correctly.

The method of JP 04426894 B2 is a method of searching for a specific sentence from a large number of sentences, and does not deal with the above problem. In the method described in JP 2011-238159 A, since extraction is not performed from a range other than a range specified in advance, it does not deal with the above problem. In the method described in U.S. Pat. No. 7,493,252, since document structure analysis is not used and the information included in a chapter, a sections, an item, and the like is not considered, it does not deal with the above problem.

### SUMMARY

The present invention is intended to solve the above problem, and it is an object to provide a sentence extracting apparatus and a program therefor capable of extracting, from sentences in a document having a hierarchical structure, a sentence to be extracted together with another sentence of contents supplementing the sentence.

To achieve the abovementioned object, according to an aspect of the present invention, a sentence extracting apparatus reflecting one aspect of the present invention comprises:

a hardware processor that

analyzes a logical configuration of a document;

extracts a first sentence including a specific key word from the document; and

extracts, as a related sentence, another sentence located in a predetermined range starting from the first sentence, in the logical configuration.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an example of a sentence extracting system according to an embodiment of the present invention;

FIG. 2 is a block diagram illustrating a schematic configuration of a server as a sentence extracting apparatus according to an embodiment of the present invention;

FIG. 3 is a diagram illustrating how a document is decomposed into a plurality of sentences;

FIG. 4 is a diagram illustrating a hierarchical structure of the document;

FIG. 5 is a diagram illustrating how a first sentence is extracted;

FIG. 6 is a diagram illustrating how a related sentence is extracted with a related sentence extracting method 1;

FIG. 7 is a diagram illustrating a list in which a body text and information of upper hierarchies are collected together for each extracted body text;

FIG. 8 is a block diagram illustrating a configuration of functions performed by the server when the related sentence is extracted with the related sentence extracting method 1;

FIG. 9 is a flowchart illustrating processing performed by the server when the related sentence is extracted with the related sentence extracting method 1;

FIG. 10 is a diagram illustrating an example different from FIG. 3 illustrating how a document is decomposed into a plurality of sentences;

FIG. 11 is a diagram illustrating the hierarchical structure of a document and how a first sentence is extracted;

FIG. 12 is a diagram illustrating how a related sentence is extracted with a related sentence extracting method 2, and how a list is created in which a body text and information of upper hierarchies are collected together for each extracted body text;

FIG. 13 is a block diagram illustrating a configuration of functions performed by the server before the related sentence is extracted with the related sentence extracting method 2; and

FIG. 14 is a flowchart illustrating processing performed by the server when the related sentence is extracted with the related sentence extracting method 2.

### DETAILED DESCRIPTION OF EMBODIMENTS

Hereinafter, one or more embodiments of the present invention will be described with reference to the drawings. However, the scope of the invention is not limited to the disclosed embodiments.

### First Embodiment

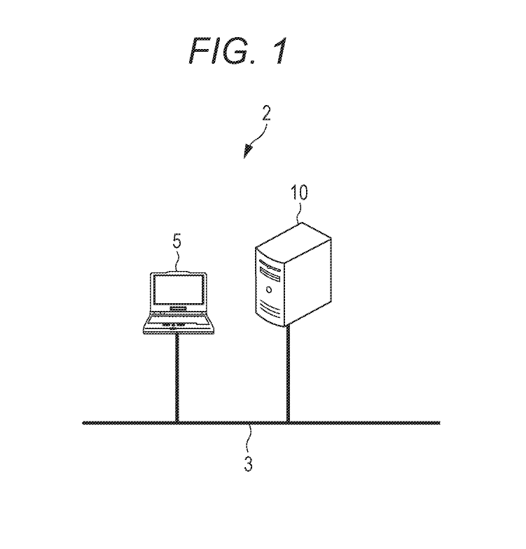

FIG. 1 is a diagram illustrating an example of a sentence extracting system 2 including a PC 5 according to the embodiment of the present invention. The sentence extracting system 2 is configured by connecting a server 10 that serves as a sentence extracting apparatus according to the present invention and a PC 5 to a network 3 such as a local area network (LAN).

The PC 5 is a terminal device such as a personal computer used by a user. The PC 5 includes a central processing unit (CPU), read only memory (ROM), random access memory (RAM), and the like, and operates on the basis of various programs such as an operating system (OS) and an application program. In the embodiment of the present invention, in addition to creating and storing a document, the PC 5 inputs the document to the server 10 and requests the server 10 to extract a specific sentence from the document input.

When the document is input from the PC 5, the server 10 extracts the specific sentence from the document and returns the extraction result to the PC 5. The document to be input to the server 10 is a document having a hierarchical structure (tree structure) that is classified into a chapter, a section, an item, a body text, and the like.

In the embodiment of the present invention, the server 10 analyzes the logical configuration of the document and extracts a sentence (referred to as a first sentence) including a specific key word. In addition, in the logical configuration of the document, another sentence located in a predetermined range starting from the sentence (first sentence) including the key word is extracted as a related sentence.

Specifically, the related sentence is extracted by the following two methods.

### (Related Sentence Extracting Method 1)

When the first sentence is a sentence belonging to an upper hierarchy of hierarchies constituting the document, such as a chapter or a section, a sentence of a lower hierarchy branching from the first sentence is extracted as a related sentence.

### (Related Sentence Extracting Method 2)

Another sentence is extracted as a related sentence, the other sentence being in a hierarchy identical to a hierarchy to which the first sentence belongs, the other sentence being at a position branched from a sentence that is a branching source of the first sentence. The hierarchy to which the first sentence belongs only needs to be other than the highest hierarchy, but in the embodiment of the present invention, only when the first sentence is a sentence in the lowest hierarchy, the related sentence is extracted by the method.

In a document, a chapter or a section often includes only fragmentary words, and details are often described in a body text. In addition, contents supplementing one body text may be described in another body text. According to the present invention, not only a sentence including a specific key word but also another sentence having a high possibility of complementing contents of the sentence can be extracted, so that a possibility becomes low that other sentences have to be read again compared to a case where only the sentence including the specific key word is extracted.

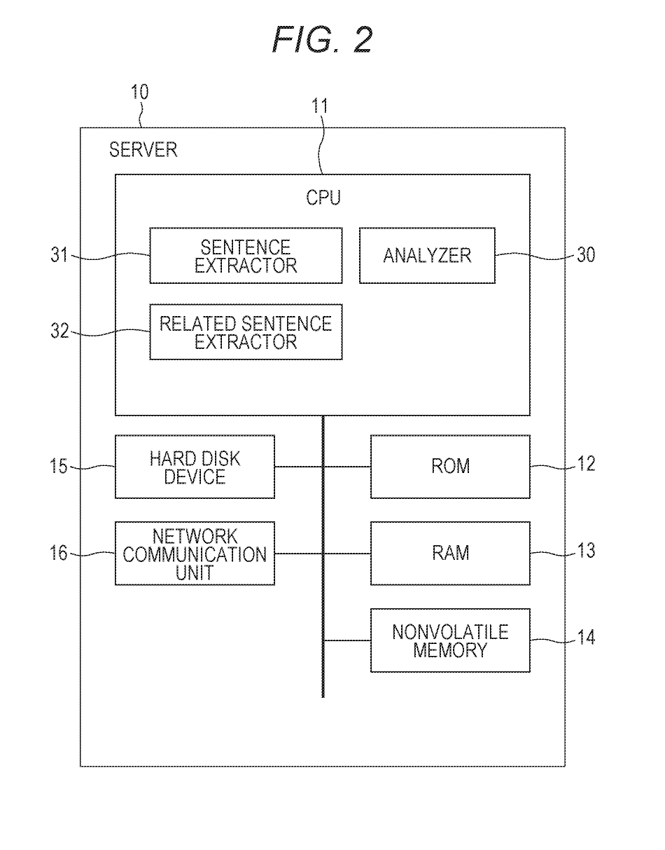

FIG. 2 is a block diagram illustrating a schematic configuration of the server 10. The server 10 includes a CPU 11 that comprehensively controls operation of the server 10. The CPU 11 is connected to ROM 12, RAM 13, a nonvolatile memory 14, a hard disk device 15, a network communication unit 16, and the like through a bus.

The CPU 11 operates on the basis of the OS program, and executes middleware, application programs, and the like on the OS program. The ROM 12 and the hard disk device 15 store various programs, and the CPU 11 executes various types of processing according to these programs, whereby functions of the server 10 are implemented.

The RAM 13 is used as a work memory that temporarily stores various data and an image memory that stores image data when the CPU 11 executes processing on the basis of the program.

The nonvolatile memory 14 is a memory (flash memory) in which stored contents are not destroyed even when the power supply is turned off and it is used for storing various types of setting information and the like. The hard disk device 15 is a large capacity nonvolatile storage device, and stores various programs and data in addition to image data and the like. In the embodiment of the present invention, a document input from the PC 5, a history of a document to which scoring is performed, each key word and its weight value, and the like are stored.

The network communication unit 16 functions to communicate with the PC 5 and other external devices via the network 3.

Further, in the embodiment of the present invention, the CPU 11 serves as an analyzer 30 that analyzes the logical configuration of a document, a sentence extractor 31 that extracts a first sentence including a specific key word from the document, and a related sentence extractor 32 that extracts, as a related sentence, another sentence located in a predetermined range starting from the first sentence, in the logical configuration of the document.

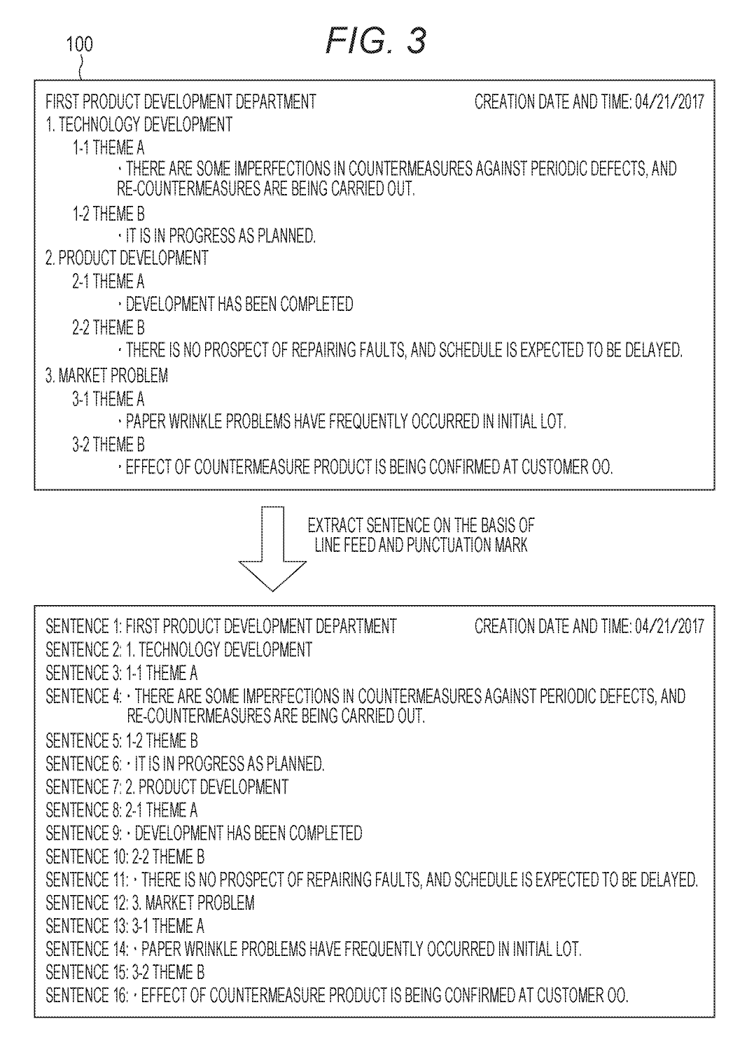

In the embodiment of the present invention, the server 10 first analyzes the document and grasps the logical configuration of the document. FIG. 3 illustrates how analysis is performed. In the embodiment of the present invention, the server 10 decomposes the document into a plurality of sentences and analyzes (determines) the logical configuration of the document from contents of the sentences.

In FIG. 3, when there is a line feed or a punctuation mark, it is regarded that they are expressions at the end of the sentence, and the document is decomposed as a sentence by being separated there. The method of decomposing the document into the plurality of sentences is not limited thereto.

A document 100 of FIG. 3 is a document having a hierarchical structure as follows.

First product development department creation date and time Apr. 21, 2017
1. Technology development

1-1 Theme A
There are some imperfections in countermeasures against periodic defects, and re-countermeasures are being carried out.

1-2 Theme B
It is in progress as planned.
   2. Product development

2-1 Theme A
Development has been completed

2-2 Theme B
There is no prospect of repairing faults, and the schedule is expected to be delayed.
   3. Market problem

3-1 Theme A
Paper wrinkle problems have occurred frequently in initial lot.

3-2 Theme B
The effect of the countermeasure product is being confirmed at the customer OO.

When the document is separated for each punctuation mark and line feed, the document can be decomposed into the following sentences 1 to 16.

Sentence 1: First product development department creation date and time Apr. 21, 2017

Sentence 2: 1. Technology development

Sentence 3: 1-1 Theme A

Sentence 4: There are some imperfections in countermeasures against periodic defects, and re-countermeasures are being carried out.

Sentence 5: 1-2 Theme B

Sentence 6: It is in progress as planned.

Sentence 7: 2. Product development

Sentence 8: 2-1 Theme A

Sentence 9: Development has been completed

Sentence 10: 2-2 Theme B

Sentence 11: There is no prospect of repairing faults, and the schedule is expected to be delayed.

Sentence 12: 3. Market problem

Sentence 13: 3-1 Theme A

Sentence 14: Paper wrinkle problems have occurred frequently in initial lot.

Sentence 15: 3-2 Theme B

Sentence 16: The effect of the countermeasure product is being confirmed at the customer OO.

When the document 100 is decomposed into the sixteen sentences, the server 10 analyzes the structure of the document. Any method can be used as a method of analyzing the document structure; however, in the embodiment of the present invention, from the indentation, sequential number assignment, and the like, analysis is performed of whether each sentence is a chapter, a section, an item, or a body text, and their hierarchical structure.

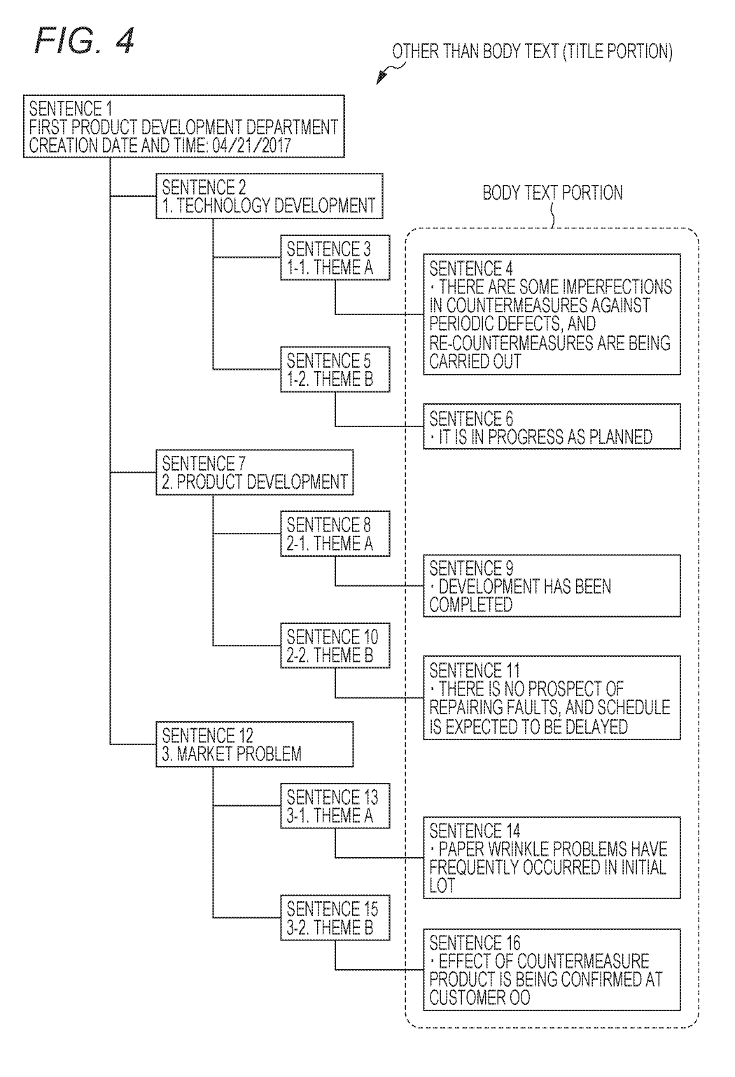

FIG. 4 illustrates a hierarchical structure (tree structure) of the document 100 obtained by analyzing the sixteen sentences. Among the sixteen sentences, it can be seen that the sentences 4, 6, 9, 11, 14, and 16 are body texts (sentences in the lowest hierarchy).

Next, the server 10 detects a sentence including a specific key word from the plurality of sentences obtained by decomposing. In the embodiment of the present invention, when a character string as the specific key word is registered in advance in the server 10 and the registered character string is in the sentence, the character string is detected.

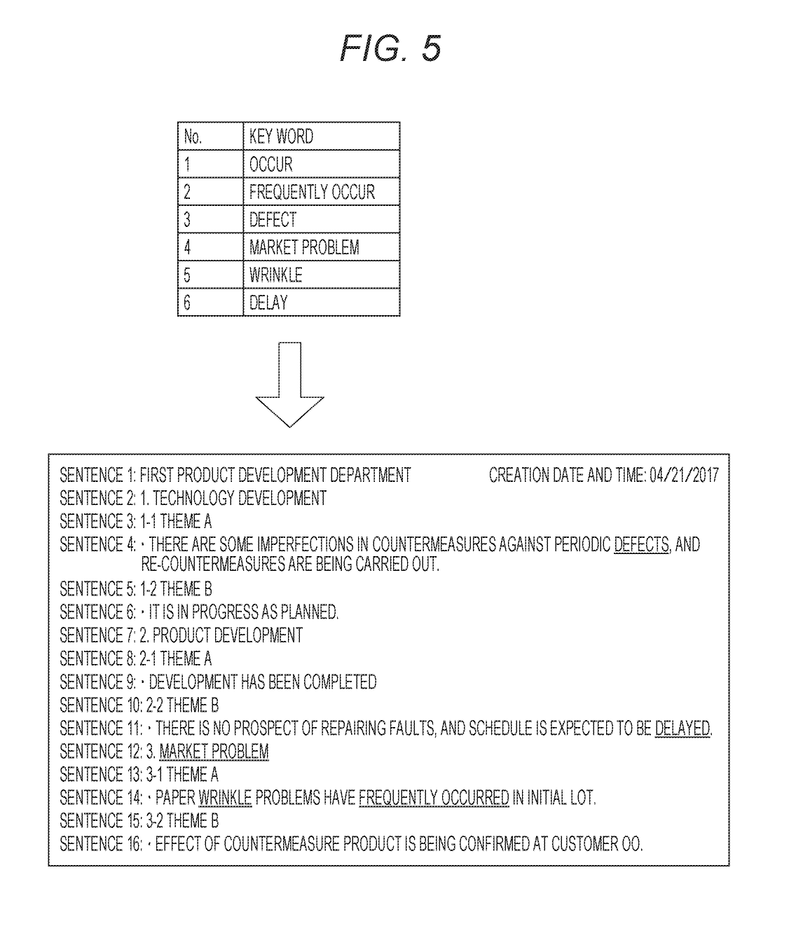

FIG. 5 illustrates how a sentence is extracted including at least one of six key words from the sixteen sentences. In the figure, key word portions in sentences are underlined. The sentences including the key words are four sentences of the sentences 4, 11, 12, and 14.

Next, a case will be described where another sentence is extracted as a related sentence with the above-described “related sentence extracting method 1” when the sentences 4, 11, 12, and 14 are the first sentences, the other sentence being located in a predetermined range starting from the first sentence.

In the related sentence extracting method 1, first, a sentence of an upper hierarchy than that of the body text is searched from the sentence extracted as the first sentence. Here, focusing on the above-described sentences 4, 11, 12, and 14, it can be seen that only the sentence 12 is a sentence belonging to the upper hierarchy than that of the body text (see FIG. 4). In the related sentence extracting method 1, as a related sentence, a sentence is extracted that is in a lower hierarchy branched from the sentence (sentence 12) and is a body text.

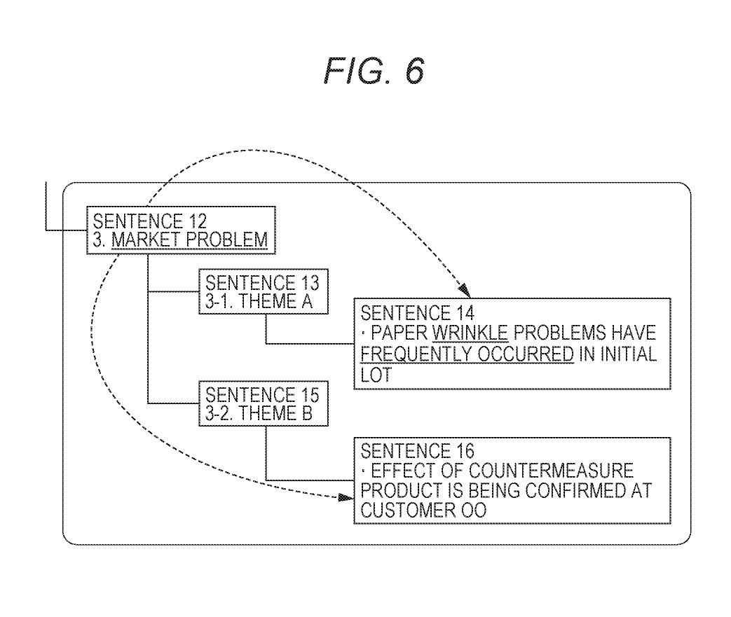

FIG. 6 illustrates how the sentence is extracted of the body text of the lower hierarchy branched from the sentence 12. In the figure, although the sentences 14 and 16 are sentences to be extracted, the sentence 14 has already been extracted as the first sentence, so that only the sentence 16 is extracted as the related sentence.

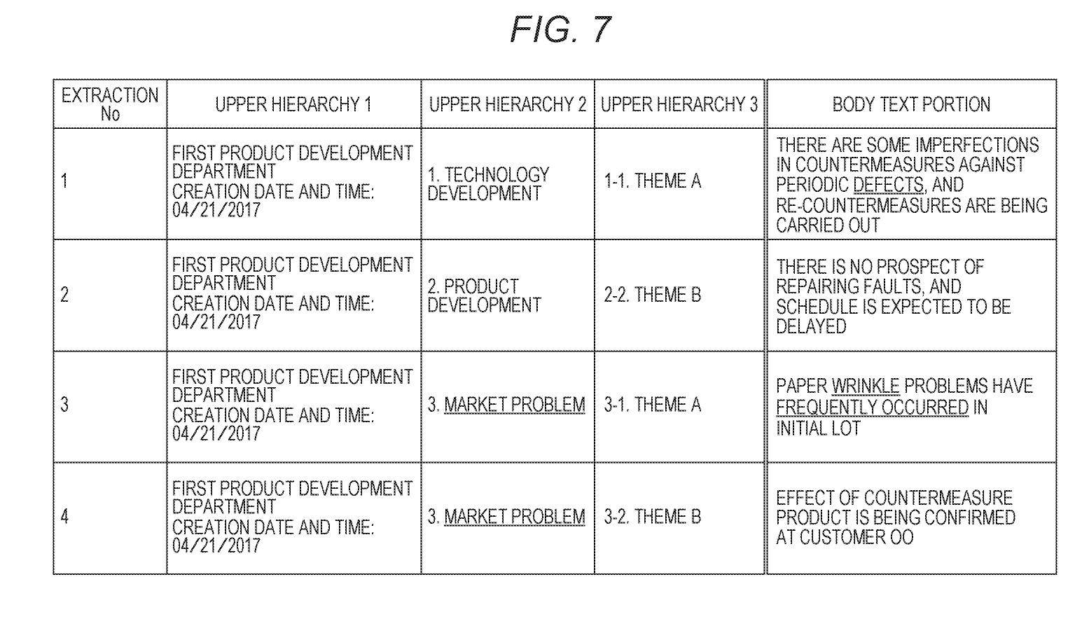

In the embodiment of the present invention, when a sentence of the body text is extracted, a branching source sentence is extracted in order toward the upper hierarchy from the sentence of the body text, and the extracted sentences are output as a list. FIG. 7 illustrates a list created on the basis of the sentences extracted in FIGS. 5 and 6.

The list of FIG. 7 is created on the basis of four sentences of the sentences 4, 11 and 14 that are sentences of the body text extracted as the first sentences, and the sentence 16 that is the sentence of the body text extracted as the related sentence. Each sentence is listed together with sentences obtained by extracting the branching source sentence in order toward the upper hierarchy. By looking at this list, the user can confirm information related to the key words of FIG. 5 without omission.

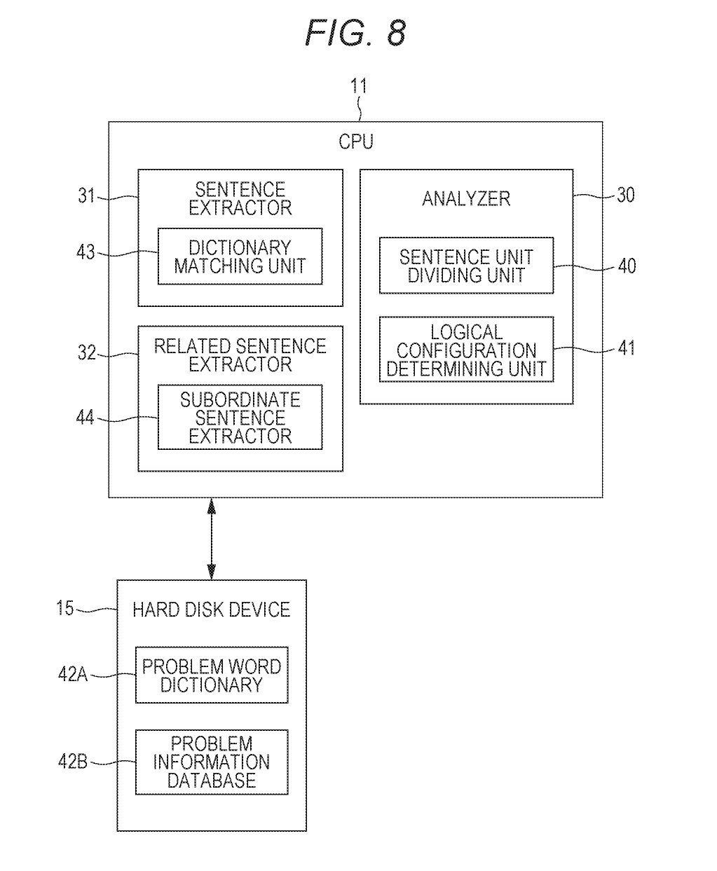

FIG. 8 illustrates a functional diagram for performing processing up to extraction of the related sentence with the related sentence extracting method 1. The analyzer 30 (see FIG. 2) serves as a sentence unit dividing unit 40 that divides a document into a plurality of sentences, and a logical configuration determining unit 41 that determines whether each sentence is a chapter, a section, an item, or a body text, and their hierarchical structure. The hard disk device 15 serves as a problem word dictionary 42A that holds a key word for extracting a first sentence.

The sentence extractor 31 serves as a dictionary matching unit 43 that compares each sentence with a key word indicated by the problem word dictionary 42A and a problem information database 42B to extract a sentence including the key word as a first sentence. The related sentence extractor 32 serves as a subordinate sentence extractor 44 that extracts, as a related sentence, a destination body text branched to a lower hierarchy from a first sentence on the basis of the first sentence. The hard disk device 15 further serves as a storage for storing the list described in FIG. 7 as the problem information database 42B.

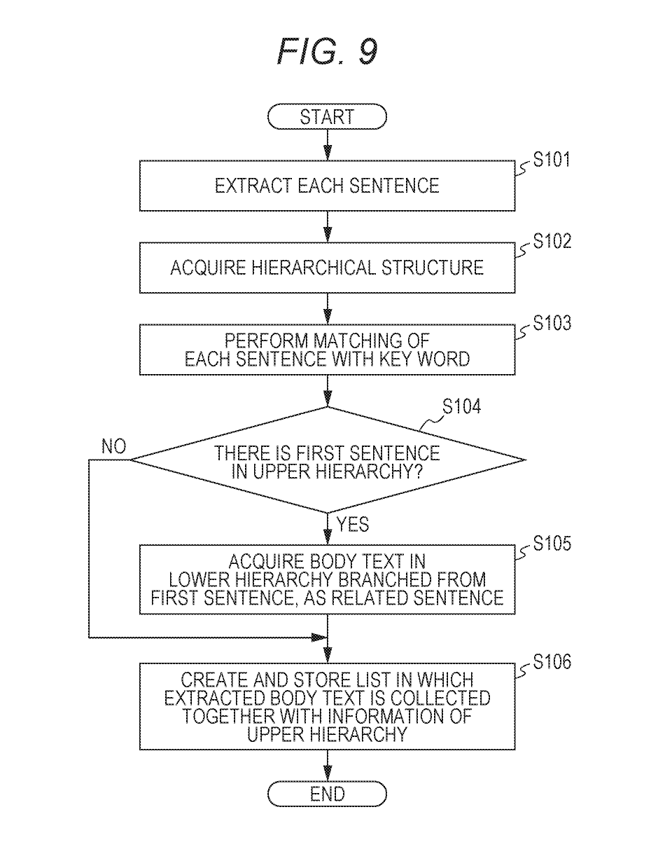

FIG. 9 illustrates a flow of the processing up to extraction of the related sentence with the related sentence extracting method 1. First, a document is divided into a plurality of sentences by the method described in FIG. 3 (step S101), and a hierarchical structure of the document is determined (step S102).

Next, from the plurality of sentences, a sentence including a key word registered in advance is extracted as a first sentence (step S103). When there is no sentence of the upper hierarchy than that of the body text in the extracted first sentences (step S104; No), the processing proceeds to step S106. When there is a sentence of the upper hierarchy than that of the body text in the extracted first sentences (step S104; Yes), a body text in the lower hierarchy branched from the sentence is acquired as a related sentence (step S105).

Thereafter, a list is created and stored in which the extracted first sentence and related sentence corresponding to the body text are collected together with information of the upper hierarchy that is a branching source of each body text (step S106), and the processing is ended.

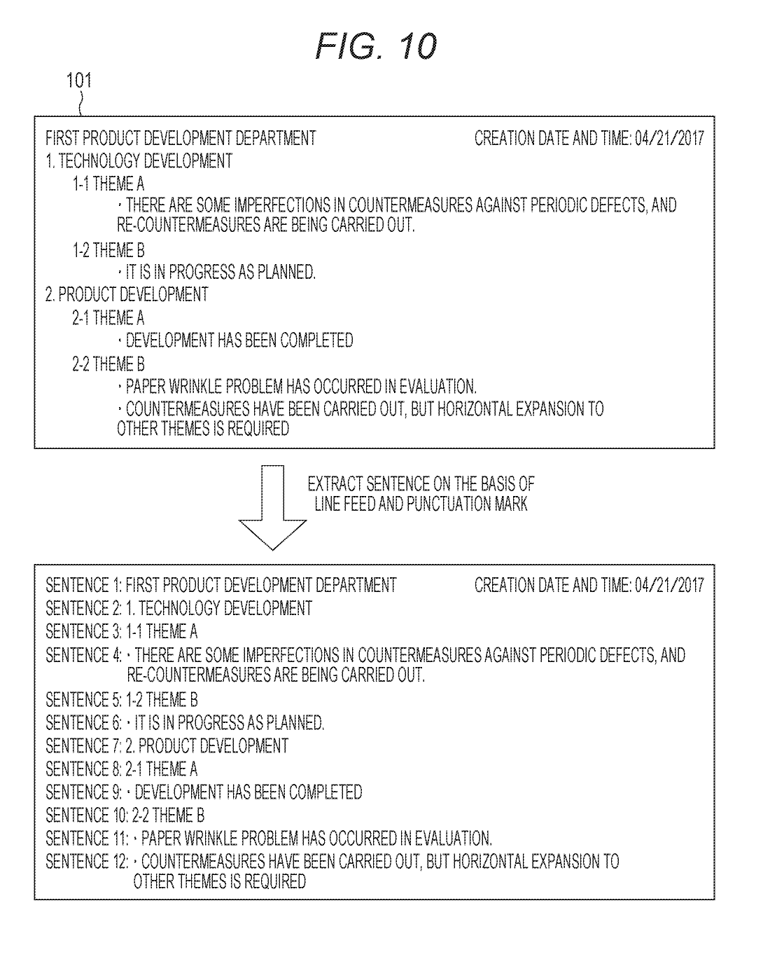

Next, the related sentence extracting method 2 will be described. FIG. 10 illustrates a document 101 different from the document 100 of FIG. 3. First, the document 101 is divided into twelve sentences (sentences 1 to 12) by the above-described method.

Among the twelve sentences of the document 101, the sentences 1 to 10 are common to the sentences 1 to 10 of the document 100 in FIG. 3. The sentences 11 and 12 of the document 101 are as follows.

Sentence 11: The paper wrinkle problem has occurred in evaluation.

Sentence 12: Countermeasures have been carried out, but horizontal expansion to other themes is required

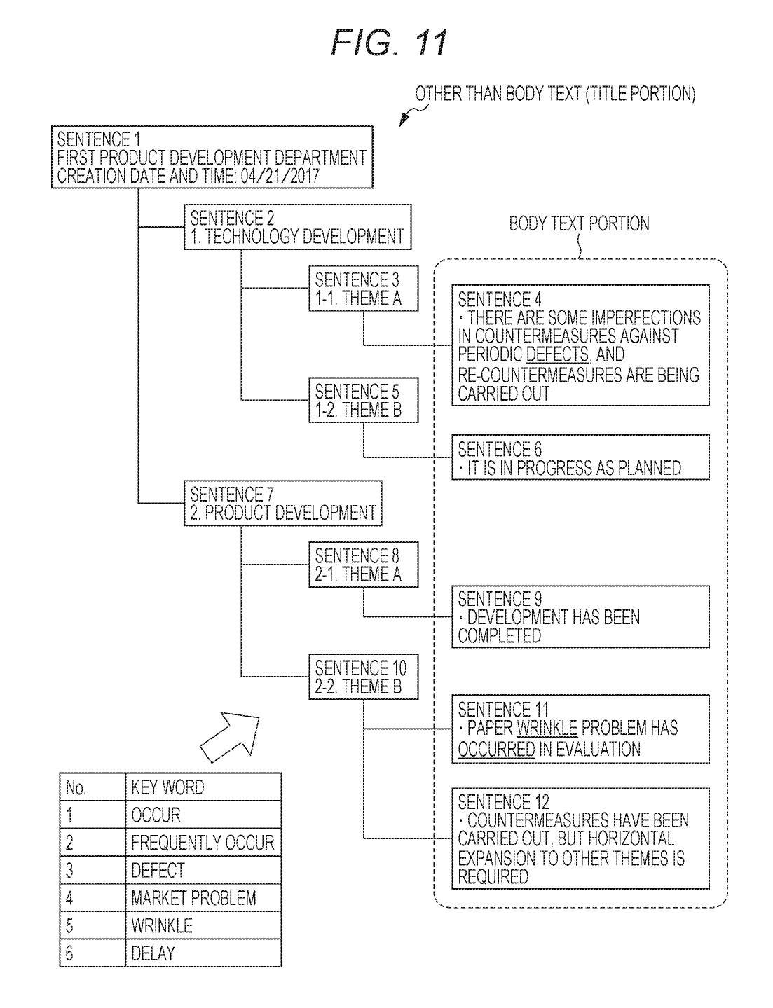

FIG. 11 illustrates a hierarchical structure (tree structure) of the document 101. According to the tree structure of FIG. 11, both the sentences 11 and 12 are sentences in the lowest hierarchy (body texts) branched from the sentence 10 (written as sentence 10 in the figure).

The sentences including the key word illustrated in FIG. 11 are two sentences, the sentence 4 and the sentence 11, and these two sentences are first extracted as the first sentences. Both the sentences 4 and 11 are body texts.

In the document 100, two or more sentences are not branched from a sentence of the immediately upper hierarchy than the hierarchy to which the body text belongs (see FIG. 4); however, in the document 101, the sentences 11 and 12 that are two body texts are branched from the sentence 10. The sentences 11 and 12 are sentences of the same hierarchy.

When the sentence 11 that is the first sentence is at a position branched from a certain sentence, and another sentence is at a position that is in the same hierarchy as that of the sentence 11 and branched from a sentence that is a branching source (branching source sentence) of the sentence 11, it is highly probable that the other sentence supplements contents of the sentence 11. Since the sentence 12 is a sentence of the same hierarchy as that of the sentence 11 that is the first sentence, and is the other sentence being at a position branched from the branching source sentence of the sentence 11, the sentence 12 is extracted as the related sentence.

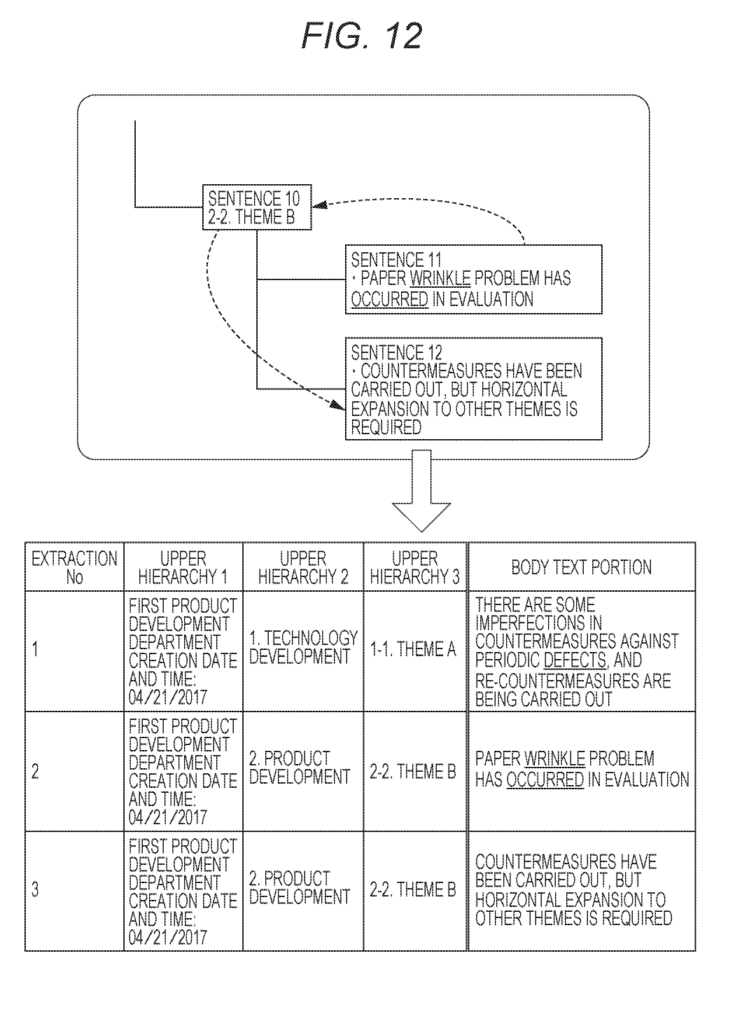

FIG. 12 illustrates a created list in which the first sentences extracted from the document 101 and sentences are collected together, the sentences being obtained by extracting the branching source sentence in order toward the upper hierarchy for each sentence of the body text out of the sentences extracted by the related sentence extracting method 2.

The list in FIG. 12 is created on the basis of three sentences of the sentences 4 and 11 that are sentences of the body text extracted as the first sentences, and the sentence 12 that is a sentence of the body text extracted as the related sentence. Each sentence is listed together with sentences obtained by extracting the branching source sentence in order toward the upper hierarchy. By looking at this list, the user can confirm information related to the key words of FIG. 11 without omission.

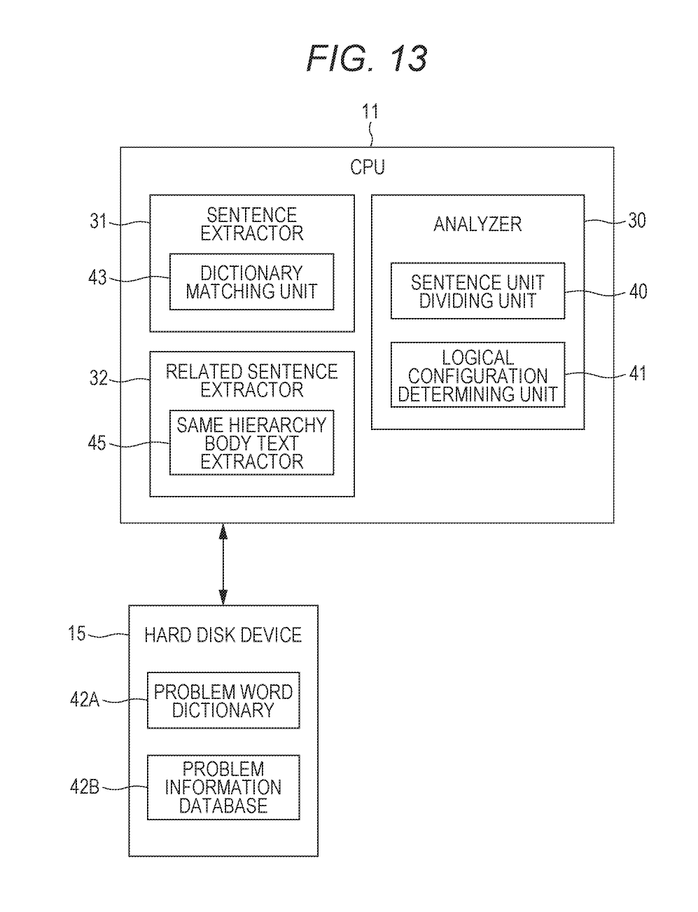

FIG. 13 is a functional diagram for performing processing up to extraction of the related sentence with the related sentence extracting method 2. The functional diagram of FIG. 13 is different from that of FIG. 8 in that the related sentence extractor 32 serves as a same hierarchy body text extractor 45 that extracts another body text belonging to a sentence of the upper hierarchy to which the first sentence that is the body text belongs, not the subordinate sentence extractor 44.

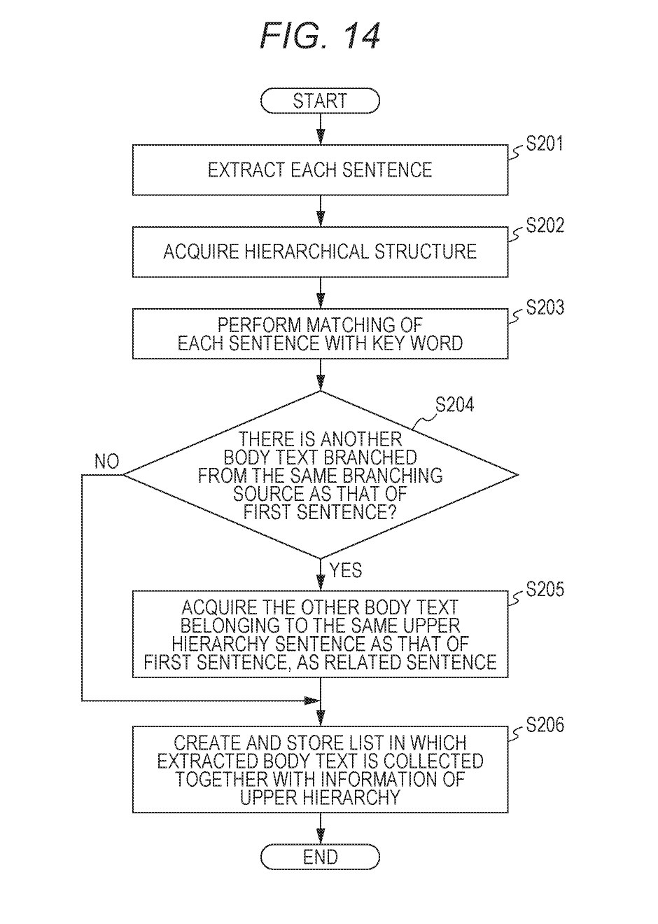

FIG. 14 illustrates processing performed before the list as illustrated in FIG. 12 is created when the related sentence extracting method 2 is used. First, a document is divided into a plurality of sentences by the method described in FIGS. 3 and 10 (step S201), and a hierarchical structure of the document is determined (step S202).

Next, from the plurality of sentences, a sentence including a key word registered in advance is extracted as a first sentence (step S203). It is checked whether or not there is another body text branched from a branching source sentence for the first sentence in the extracted first sentences (step S204), and when there is no other body text (step S204; No), the processing proceeds to step S206.

When there is the other body text (step S204; Yes), the sentence of the body text is acquired as a related sentence (step S205).

Thereafter, a list is created and stored in which the extracted first sentence and related sentence corresponding to the body text are collected together with information of the upper hierarchy that is a branching source of each body text (step S206), and the processing is ended.

In the above, the embodiment of the present invention has been described with reference to the drawings; however, the specific configuration is not limited to that illustrated in the embodiment, and even a configuration including changes and additions within the scope not deviating from the gist of the present invention is also included in the present invention.

In the embodiment of the present invention, the server 10 serves as the sentence extracting apparatus of the present invention; however, the sentence extracting apparatus is not limited thereto. For example, another device such as the PC 5 or an MFP may serve as the sentence extracting apparatus. In addition, a program causing an information processing apparatus to operate as the server 10 in the embodiment is also the present invention.

The method of extracting the first sentence from the document is not limited to that described in the embodiment of the present invention. The key words are not limited to those described in the embodiment of the present invention. The predetermined range starting from the first sentence is not limited to that described in the embodiment of the present invention. A related sentence may be extracted by a method other than the related sentence extracting method 1 and the related sentence extracting method 2, as long as it is a method of extracting a sentence in a range highly likely to be related to the first sentence.

In the embodiment of the present invention, a list is created by extracting a branching source sentence in order toward the upper hierarchy for each sentence of the extracted body text; however, without creating the list, only the first sentence and related sentence may be output as an extraction result.

In the embodiment of the present invention, the document is limited to a document having a hierarchical structure (tree structure); however, the document may be a document having no hierarchical structure. In the case of the document having no hierarchical structure, for example, sentences before and after a sentence extracted as a first sentence may be extracted as related sentences.

According to an embodiment of the present invention, with the sentence extracting apparatus and the program of the present invention, a sentence in a document having a hierarchical structure can be weighted by considering information other than the sentence.

Although embodiments of the present invention have been described and illustrated in detail, the disclosed embodiments are made for purposes of illustration and example only and not limitation. The scope of the present invention should be interpreted by terms of the appended claims.

What is claimed is:

1. A sentence extracting apparatus comprising:
a hardware processor that
analyzes a logical configuration of a document;
extracts a first sentence including a specific key word from the document; and
extracts, as a related sentence, another sentence located in a predetermined range starting from the first sentence, in the logical configuration.

2. The sentence extracting apparatus according to claim 1, wherein
the document has a hierarchical structure.

3. The sentence extracting apparatus according to claim 2, wherein
the hardware processor extracts a sentence as the related sentence, the sentence belonging to a lower hierarchy than a hierarchy to which the first sentence belongs in the logical configuration, the sentence being located at a place branched from the first sentence.

4. The sentence extracting apparatus according to claim 2, wherein
the hardware processor extracts another sentence as the related sentence, the other sentence being in a hierarchy identical to a hierarchy to which the first sentence belongs in the logical configuration, the other sentence being at a position branched from a sentence that is a branching source of the first sentence.

5. The sentence extracting apparatus according to claim 1, wherein
the hardware processor extracts a sentence as a first sentence when a character string included in the sentence matches a character string registered in advance.

6. A non-transitory recording medium storing a computer readable program causing
an information processing apparatus to perform
operating as the sentence extracting apparatus according to claim 1.
